(19) United States
(12) Patent Application Publication
(10) Pub. No.: US 2025/0323557 A1
(43) Pub. Date: Oct. 16, 2025

(54) REPAIR SYSTEM

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Shunichi KAWABATA, Yokohama Kanagawa (JP); Akihiko HIROSE, Kamakura Kanagawa (JP); Hirotaka TSUBAKIHARA, Kawasaki Kanagawa (JP); Mitsunori YUMINAMOCHI, Chigasaki Kanagawa (JP); Hidehito MATSUZAKI, Yokohama Kanagawa (JP); Takaaki KIMURA, Ota Tokyo (JP); Hiroyuki SATO, Fujisawa Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 18/738,212

(22) Filed: Jun. 10, 2024

(30) Foreign Application Priority Data
Apr. 12, 2024 (JP) 2024-064713

(51) Int. Cl. H02K 15/00; H02K 15/02

(52) U.S. Cl. CPC H02K 15/50; H02K 15/02

(57) ABSTRACT

The repair system of an embodiment includes a traveling device that travels while being inserted into a gap interposed between a rotor and stator in the rotary electric machine and a control device that controls operation of the traveling device. The traveling device has a moving mechanism moving the traveling device in the gap and a repair mechanism repairing a repair object part of the rotary electric machine in the gap. The repair mechanism includes a nozzle discharging repair material for repairing the repair object part from a nozzle discharge port. When repairing the repair object part, the control device controls operations of the moving mechanism and the repair mechanism so that the repair material is applied to the repair object part by discharging the repair material from the nozzle discharge port of the nozzle while moving the traveling device.

### CROSSREFERENCE TO RELATED APPLICATIONS

This application is based upon and claims the benefit of priority from Japanese Patent Application No. 2024-064713, filed on Apr. 12, 2024, the entire contents of which are incorporated herein by reference.

### FIELD

Embodiments disclosed herein relate to a repair system.

### BACKGROUND

In a rotary electric machine such as a power generator or an electric motor, a gap is interposed between a stator and rotor. The stator has a stator slot formed on a surface of a stator core facing the rotor with an interposing gap, and a stator coil housed in the stator slot is fixed inside the stator slot by a stator wedge. Similarly, the rotor has a rotor slot formed on a surface of a rotor core facing the stator with an interposing gap, and a rotor coil housed in the rotor slot is fixed inside the rotor slot by a rotor wedge.

The rotary electric machine is inspected to avoid occurrence of major failures. In the inspection of the rotary electric machine, for example, a fixing state (looseness) or other states of the stator wedge fixed to the stator core in the stator is examined. For example, the inspection of the fixing state or other states of the stator wedge is performed by visually observing the stator wedge after disassembling to remove the rotor from the stator because the stator wedge is installed on the surface of the stator where the gap is located. In addition, the inspection of the fixing state or other states of the stator wedge is also performed after the disassembly work, for example, based on a sound generated when the stator wedge is struck with a hammer. Therefore, when performing the above inspections, the period during which the rotary electric machine is stopped may be prolonged. In addition, a large number of workers may be required to perform the above inspections because they involve the disassembly work of the rotary electric machine.

For this reason, a traveling system has been proposed to perform inspections by inserting a traveling device into the gap interposed between the stator and rotor without disassembling the rotary electric machine, and by having a control device, which controls the traveling of the traveling device in the gap.

In a rotary electric machine, repairs may be required depending on results of inspections and other factors. For example, when defects (looseness, or other defects) occur in a fixing state of the stator wedge fixed to the stator core in the stator, repairs become necessary. However, since conventional traveling systems do not have a means to perform repairs in the gap interposed between the stator and rotor, it is difficult to carry out repairs efficiently.

Therefore, the problem to be solved by the present invention is to provide a repair system that can easily achieve efficient repairs of rotary electric machines.

### BRIEF DESCRIPTION OF THE DRAWINGS

FIG. 1 is a diagram schematically illustrating a hydraulic turbine power generation facility 30 including a rotary electric machine 20 in an embodiment.

FIG. 2A is an enlarged diagram of a partial cross-section of a stator 23 (plane perpendicular to an axial direction of a rotation center axis AX (xy-plane)) in the embodiment.

FIG. 2B illustrates a radial direction of the rotation center axis AX as a sight line regarding an inner peripheral surface of the stator 23 in the embodiment.

FIG. 3 is a block diagram schematically illustrating a repair system 800 in the embodiment.

FIG. 4A is a diagram schematically illustrating an entire traveling device 500 in the repair system 800 of the embodiment.

FIG. 4B is a diagram schematically illustrating the entire traveling device 500 in the repair system 800 of the embodiment.

FIG. 4C is a diagram schematically illustrating an enlarged part where an imaging device 52 is provided in the traveling device 500 of the embodiment.

FIG. 4D is a diagram schematically illustrating an enlarged part where a repair mechanism 55 is provided in the traveling device 500 of the embodiment.

FIG. 5A is a flow diagram illustrating operations of a “straight-ahead control” in the repair system 800 of the embodiment.

FIG. 5B is a diagram illustrating an example of imaging data used when the “straight-ahead control” is performed in the repair system 800 of the embodiment.

FIG. 6 is a flow diagram illustrating operations when performing “repair” in the repair system 800 of the embodiment.

FIG. 7 is a diagram schematically illustrating a part of the traveling device 500 in Modification example 1.

FIG. 8A is a diagram schematically illustrating an enlarged part where the repair mechanism 55 is provided in Modification example 2.

FIG. 8B is a diagram schematically illustrating a nozzle 552 in Modification example 2.

### DETAILED DESCRIPTION

A repair system of this embodiment includes a traveling device that travels while being inserted into a gap interposed between a rotor and stator in a rotary electric machine and a control device that controls operation of the traveling device. The traveling device has a moving mechanism that moves the traveling device in the gap and a repair mechanism that repairs a repair object part of the rotary electric machine in the gap. The repair mechanism includes a nozzle that discharges repair material to repair the repair object part from a nozzle discharge port. When repairing the repair object part, the control device controls the operations of the moving mechanism and the repair mechanism so that the repair material is applied to the repair object part by discharging the repair material from the nozzle discharge port of the nozzle while the traveling device is moved.

### [A] Rotary Electric Machine 20

Before describing a repair system of this embodiment, a description will be given concerning an example of a rotary electric machine 20 on which the repair system travels.

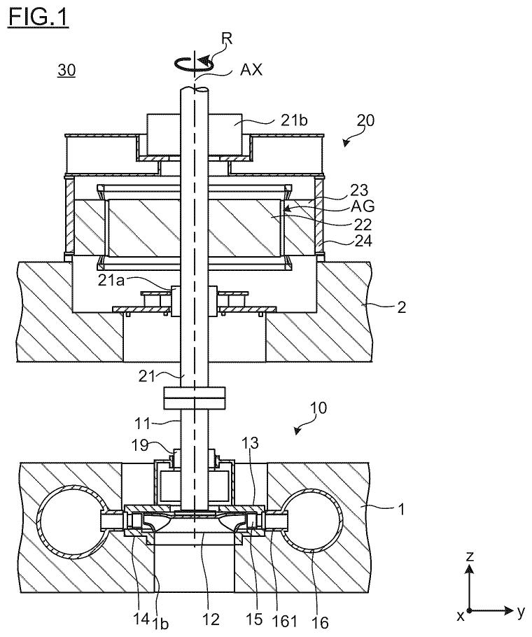

FIG. 1 is a diagram schematically illustrating a hydraulic turbine power generation facility 30 including a rotary electric machine 20 in this embodiment. In FIG. 1, a longitudinal direction is a vertical direction z (gravity direction), a direction perpendicular to the paper is a first horizontal direction x, and a lateral direction is a second horizontal direction y. In FIG. 1, a longitudinal section including the rotation center axis AX is illustrated.

As illustrated in FIG. 1, the hydraulic turbine power generation facility 30 is equipped with a hydraulic turbine 10 and the rotary electric machine 20. The hydraulic turbine power generation facility 30 is of a vertical-shaft type in which the rotation center axis AX is along the vertical direction z. During power generation operation, power generation is performed by the rotary electric machine 20 driven by rotation of the hydraulic turbine 10.

### [A-1] Hydraulic Turbine 10

The hydraulic turbine 10 is, for example, a Francis type and, as illustrated in FIG. 1, has a hydraulic turbine rotor shaft 11, a runner 12, an upper cover 13, a lower cover 14, guide vanes 15, and a casing 16, and is provided on a hydraulic turbine floor foundation 1.

The hydraulic turbine 10 is configured so that during the power generation operation, water is supplied from the casing 16 to the runner 12 through the guide vanes 15, causing the runner 12 to rotate with the hydraulic turbine rotor shaft 11.

### [A-1-1] Hydraulic Rotor Shaft 11

Concretely, in the hydraulic turbine 10, the hydraulic turbine rotor shaft 11 is rotatably supported by a hydraulic turbine bearing 19 so that the rotation center axis AX is along the vertical direction z.

### [A-1-2] Runner 12

The runner 12 has its rotation center axis AX along the vertical direction z and is connected to a lower-end portion of the hydraulic turbine rotor shaft 11. The runner 12 is installed so that a plurality of runner blades are aligned in a rotation direction between a runner crown and a runner band.

### [A-1-3] Upper Cover 13

The upper cover 13 is provided above the runner 12. The upper cover 13 has the hydraulic turbine rotor shaft 11 through a center portion and covers an upper surface of the runner 12 at a side portion of an outer peripheral surface of the hydraulic turbine rotor shaft 11.

### [A-1-4] Lower Cover 14

The lower cover 14 is provided below the runner 12. The lower cover 14 covers a lower surface of the runner 12 at an outer peripheral portion of a discharge pipe 1b formed on the hydraulic turbine floor foundation 1.

### [A-1-5] Guide Vane 15

A plurality of guide vanes 15 are arranged between the upper cover 13 and the lower cover 14, surrounding an outer periphery of the runner 12. The guide vanes 15 are configured to regulate a flow rate of water flowing into the runner 12 by changing an opening degree.

### [A-1-6] Casing 16

The casing 16 is donut-shaped and is installed to surround a periphery of the plurality of guide vanes 15 with a speed ring 161 therebetween.

### [A-2] Rotary Electric Machine 20

The rotary electric machine 20 has a rotary electric machine rotor shaft 21, a rotor 22, and a stator 23, as illustrated in FIG. 1, and is provided on a rotary electric machine floor foundation 2. The rotary electric machine 20 is, for example, an inner-rotor type and is used as a power generator that generates electricity when the rotor 22 rotates inside the stator 23 during power generation operation.

### [A-2-1] Rotary Electric Machine Rotor Shaft 21

Concretely, in the rotary electric machine 20, the rotary electric machine rotor shaft 21 is cylindrical in shape, has the rotation center axis AX along the vertical direction z, and is rotatably supported by a rotary electric machine bearing 21a and a rotary electric machine bearing 21b. The rotary electric machine bearing 21a includes, for example, a thrust bearing and a radial bearing and rotatably supports a lower portion of the rotary electric machine rotor shaft 21. The rotary electric machine bearing 21b includes, for example, the radial bearing and rotatably supports an upper portion of the rotary electric machine rotor shaft 21. A lower-end portion of the rotary electric machine rotor shaft 21 is coupled to an upper-end portion of the hydraulic turbine rotor shaft 11 so that rotational torque of the hydraulic turbine 10 is transmitted to the rotary electric machine 20.

### [A-2-2] Rotor 22

The rotor 22 is cylindrical in shape and is fixed to the rotary electric machine rotor shaft 21 so that it is coaxial to the rotary electric machine rotor shaft 21.

Although not illustrated in the figure, the rotor 22 has a rotor coil housed inside a rotor slot formed on an outer peripheral surface of a rotor core, and the rotor coil is fixed inside the rotor slot by a rotor wedge.

### [A-2-3] Stator 23

The stator 23 is cylindrical in shape, coaxial to a rotary shaft 201, and installed to surround the rotor 22 with a gap AG (air gap) therebetween. The stator 23 is housed in a frame 24, which is installed on an upper surface of the rotary electric machine floor foundation 2, and is fixed to an inner peripheral surface of the frame 24.

### [A-3] Details of Stator 23

A detailed configuration of the stator 23 is exemplified.

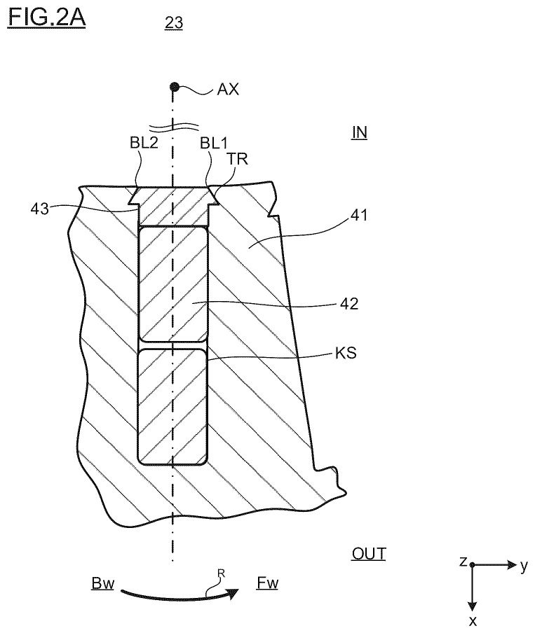

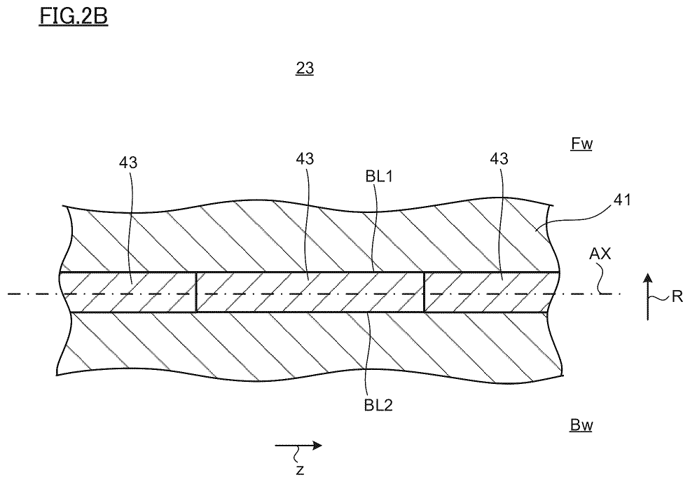

FIG. 2A is an enlarged diagram of a partial cross-section of the stator 23 (plane perpendicular to an axial direction of the rotation center axis AX (xy-plane)) in this embodiment. FIG. 2B illustrates a radial direction of the rotation center axis AX as a sight line regarding an inner peripheral surface of the stator 23 in the embodiment.

As illustrated in FIG. 2A, the stator 23 includes a stator core 41, a stator coil 42, and a stator wedge 43.

### [A-3-1] Stator Core 41

In the stator 23, the stator core 41 has a stator slot KS (coil slot). The stator slot KS is a groove recessed in the radial direction of the rotation center axis AX (longitudinal direction in FIG. 2A) and formed at a portion located on an inner peripheral side IN (upper side in FIG. 2A) in the stator core 41. Here, the stator slot KS extends in the axial direction of the rotation center axis AX. Although the figure is omitted, a plurality of stator slots KS are provided so that they are spaced apart and aligned in a rotation direction R of the rotation center axis AX.

### [A-3-2] Stator Coil 42

The stator coil 42 is housed in the stator slot KS formed in the stator core 41. Although the figure is omitted, the stator coil 42 extends in the axial direction of the rotation center axis AX in the stator slot KS, and an insulator (not illustrated) is interposed between the stator core 41 and the stator coil 42.

### [A-3-3] Stator Wedge 43

The stator wedge 43 is installed on the inner peripheral side IN of the stator coil 42 in the stator slot KS. The stator wedge 43 is provided to fix the stator coil 42 to the stator slot KS.

Here, a plurality of stator wedges 43 are inserted in the axial direction of the rotation center axis AX on the inner peripheral side IN of the stator slot KS. An inner peripheral surface of the stator wedge 43 and an inner peripheral surface of the stator core 41 are flush and without steps. Therefore, boundary portions BL1 and BL2 between the stator core 41 and the stator wedge 43 exist on the inner peripheral surface of the stator 23 as linear portions extending linearly in the axial direction along the rotation center axis AX (see FIG. 2A and FIG. 2B).

### [B] Repair System 800

A repair system 800 used for repairing the rotary electric machine 20 (see FIG. 1) is described.

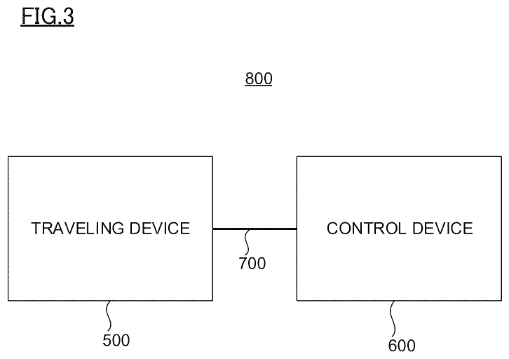

FIG. 3 is a block diagram schematically illustrating the repair system 800 in the embodiment.

As illustrated in FIG. 3, the repair system 800 of this embodiment includes a traveling device 500 and a control device 600, and the traveling device 500 and the control device 600 can communicate with each other through a cable 700.

### [B-1] Traveling Device 500

The traveling device 500 is a self-propelled robot, details of which will be described later, and is configured to travel while being inserted into the gap AG interposed between the rotor 22 and stator 23 when performing repairs of the rotary electric machine 20 (see FIG. 1).

### [B-2] Control Device 600

The control device 600 is provided to remotely control operation of the traveling device 500. The control device 600 includes an arithmetic unit (computer) and a memory device and is configured so that the arithmetic unit executes control of the operation of the traveling device 500 using programs stored by the memory device.

Here, the control device 600 performs control so that the traveling device 500 performs the repairs of the rotary electric machine 20 in response to operation commands input by an operator using, for example, a mouse, keyboard, or other operating devices (not illustrated). In addition, the control device 600 also controls display of information, or the like concerning the repairs performed by the traveling device 500, for example, on a display.

### [C] Details of Traveling Device 500

Details of the traveling device 500, which makes up the repair system 800 (see FIG. 3) are described.

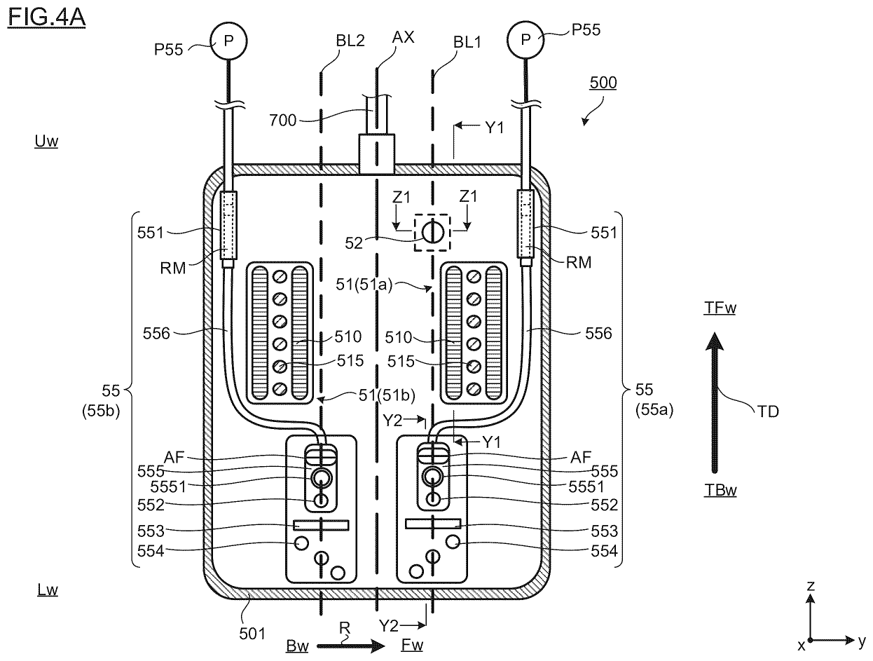

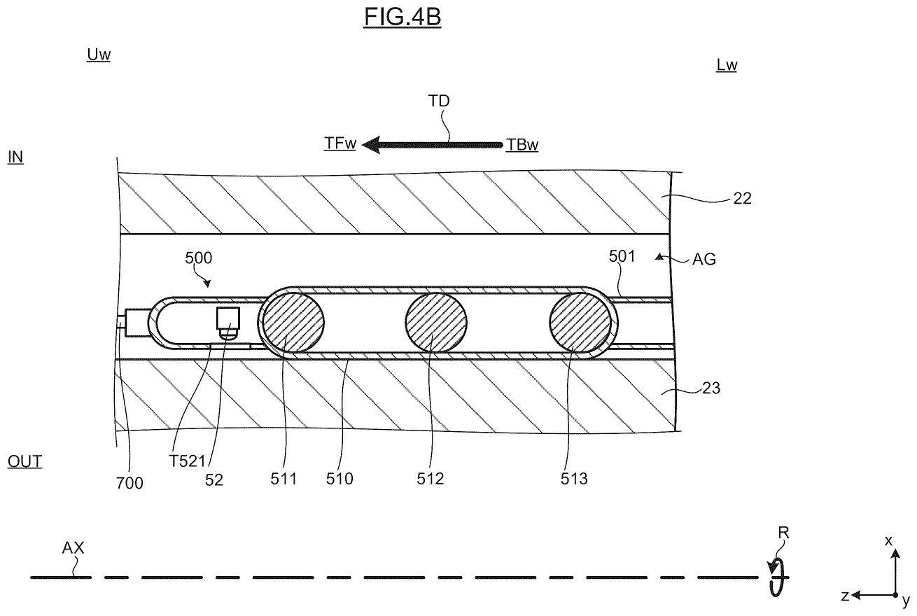

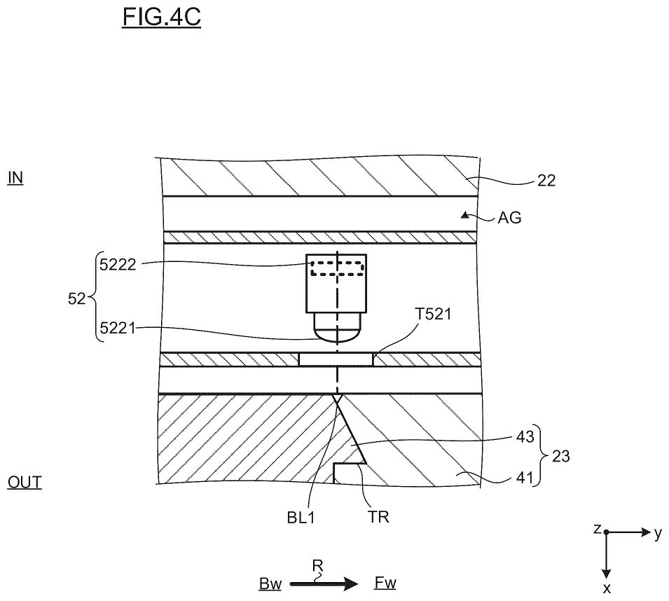

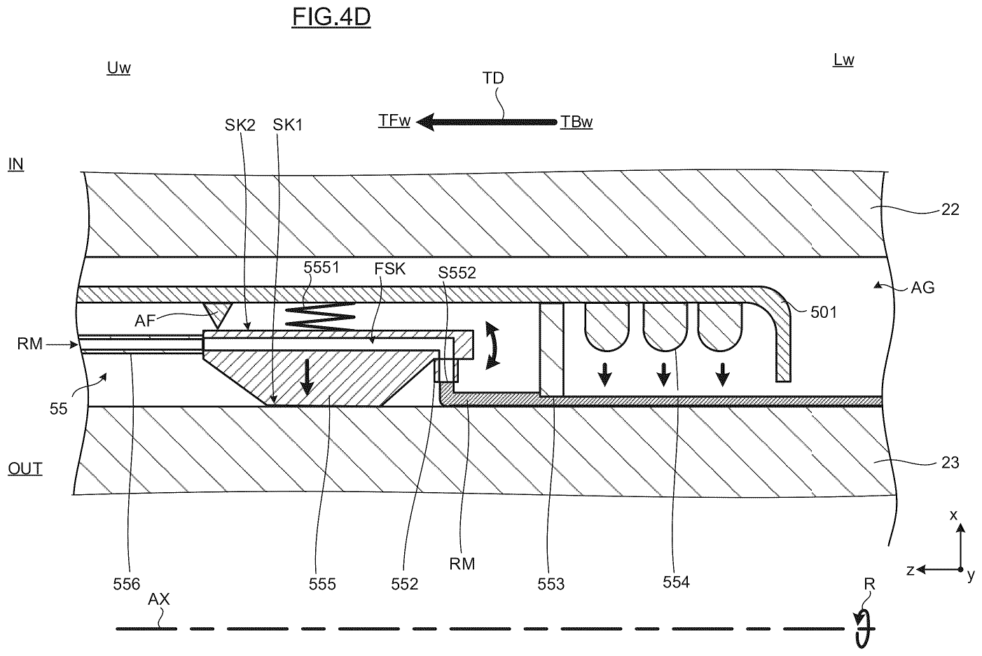

FIG. 4A and FIG. 4B are diagrams schematically illustrating the entire traveling device 500 in the repair system 800 of this embodiment.

In FIG. 4A and FIG. 4B, the traveling device 500 is illustrated when it travels along the vertical direction z in the gap AG between the rotor 22 and stator 23.

FIG. 4A illustrates a cross-section of a plane (corresponding to a yz-plane) defined by the axial direction (corresponding to the vertical direction z) along the rotation center axis AX and the rotation direction R (corresponding to the second horizontal direction y) of the traveling device 500. In FIG. 4A, the upper part is an upper side Uw in the vertical direction z, the lower part is a lower side Lw in the vertical direction z, the right side is a forward side Fw in the rotation direction R, and the left side is a backward side Bw in the rotation direction R.

FIG. 4B illustrates a cross-section of a plane (corresponding to an xz-plane; Y1-Y1 portion in FIG. 4A) defined by the axial direction along which the rotation center axis AX is aligned (corresponding to the vertical direction z) and the radial direction of the rotation center axis AX (corresponding to the first horizontal direction x in FIG. 4B), in the traveling device 500. In FIG. 4B, the upper part is the inner peripheral side IN in the radial direction, the lower part is the outer peripheral side OUT in the radial direction, the right side is the lower side Lw in the vertical direction z, and the left side is the upper side Uw in the vertical direction z.

As illustrated in FIG. 4A and FIG. 4B, the traveling device 500 includes a traveling device casing unit 501, a moving mechanism 51, an imaging device 52, and a repair mechanism 55, and moves in the gap AG between the rotor 22 and stator 23, while being attracted to the stator 23, to perform repairs of the rotary electric machine 20.

The traveling device 500 travels along the axial direction and performs the repairs by controlling operation of the moving mechanism 51, operation of the imaging device 52, and operation of the repair mechanism 55 according to control signals transmitted from the control device 600 through the cable 700. The traveling device 500 of this embodiment performs the repair by applying repair material RM to the boundary portions BL1 and BL2 between the stator core 41 and the stator wedge 43 due to a defect (looseness, or other defects) in a fixing state in which the stator wedge 43 is fixed to the stator slot KS of the stator core 41. A traveling direction TD during repair, in which the traveling device 500 travels when performing the repair, is along the vertical direction z. For example, a forward side TFw of the traveling direction TD during repair is the upper side Uw in the vertical direction z, and a backward side TBw of the traveling direction TD during repair is the lower side Lw in the vertical direction z.

The following is a detailed description of each of the parts that make up the traveling device 500.

### [C-1] Traveling Device Casing Unit 501

The traveling device casing unit 501 has an outline shape that can be inserted into the gap AG between the rotor 22 and stator 23, as illustrated in FIG. 4A and FIG. 4B. The traveling device casing unit 501 houses the moving mechanism 51, the imaging device 52, and the repair mechanism 55 inside.

### [C-2] Moving Mechanism 51

The moving mechanism 51 is provided to move the traveling device 500 in the gap AG between the rotor 22 and stator 23, as illustrated in FIG. 4A and FIG. 4B.

In this embodiment, as illustrated in FIG. 4A, two moving mechanisms 51, a moving mechanism 51a and a moving mechanism 51b, are installed in the traveling device casing unit 501. The moving mechanism 51a and moving mechanism 51b are side by side and separated in the rotation direction R when the traveling device 500 travels along the vertical direction z.

Each of the moving mechanism 51a and moving mechanism 51b is configured such that a pair of crawlers 510 sandwich a plurality of permanent magnets 515. In each of the moving mechanism 51a and moving mechanism 51b, the pair of crawlers 510 are arranged spaced apart in the rotation direction R and the plurality of permanent magnets 515 are arranged in the vertical direction z when the traveling device 500 travels along the vertical direction z.

As illustrated in FIG. 4B, in the moving mechanism 51, the crawler 510 is, for example, a ring connected with a plurality of track shoes (not illustrated) surrounding a sprocket wheel 511, a roller wheel 512, and an idler wheel 513, and the crawler 510 is driven by the rotation of the sprocket wheel 511 by a motor (not illustrated).

In the moving mechanism 51, the permanent magnets 515 are provided to attract the traveling device 500 to the stator 23 by magnetic force, as can be seen from FIG. 4B.

### [C-3] Imaging Device 52

The imaging device 52 is provided to capture images in the gap AG between the rotor 22 and stator 23 to acquire imaging data. The imaging device 52 is configured to capture the image of the inner peripheral surface of the stator 23 with the traveling device 500 inserted into the gap AG.

FIG. 4C is a diagram schematically illustrating an enlarged part where the imaging device 52 is provided in the traveling device 500 of the embodiment.

FIG. 4C illustrates a cross-section of a plane (corresponding to the xy-plane; Z1-Z1 portion in FIG. 4A) in which the rotation center axis AX is perpendicular. In FIG. 4C, the upper part is the inner peripheral side IN in the radial direction, the lower part is the outer peripheral side OUT in the radial direction, the right side is the forward side Fw in the rotation direction R, and the left side is the backward side Bw in the rotation direction R.

The imaging device 52 is a camera including an objective lens 5221 and an imaging element 5222 and is installed in the traveling device casing unit 501 so that a subject image is incident on the imaging element 5222 through the objective lens 5221 to acquire imaging data, as illustrated in FIG. 4C. In this embodiment, an optical axis of the objective lens 5221 of the imaging device 52 is along the radial direction when the traveling device 500 travels along the vertical direction z in the gap AG.

Although details are described below, in this embodiment, the imaging device 52 acquires the imaging data by capturing the image of the boundary portion BL1 between the stator core 41 and the stator wedge 43.

### [C-4] Repair Mechanism 55

The repair mechanism 55 is installed in the traveling device casing unit 501 to repair a repair object part of the rotary electric machine 20 in the gap AG between the rotor 22 and stator 23, as illustrated in FIG. 4A and FIG. 4B. In this embodiment, the repair object parts are the boundary portions BL1 and BL2 between the stator core 41 and the stator wedge 43.

In this embodiment, as illustrated in FIG. 4A, two repair mechanisms 55, a repair mechanism 55a and a repair mechanism 55b, are installed in the traveling device casing unit 501. The repair mechanism 55a and repair mechanism 55b are spaced apart and aligned in the rotation direction R when the traveling device 500 travels along the vertical direction Z.

Each of the repair mechanisms 55a and 55b has a storage part 551, a nozzle 552, a scraper 553, a solidification device 554, and a skid 555, as illustrated in FIG. 4A. The parts making up the repair mechanism 55a and the parts making up the repair mechanism 55b are symmetrically arranged with the rotation center axis AX therebetween when the traveling device 500 travels along the vertical direction z. On the traveling device 500, the repair mechanism 55a is configured to apply the repair material RM to the boundary portion BL1, and the repair mechanism 55b is configured to apply the repair material RM to the boundary portion BL2.

FIG. 4D is a diagram schematically illustrating an enlarged part where the repair mechanism 55 is provided in the traveling device 500 of the embodiment.

FIG. 4D illustrates a cross-section of a plane (corresponding to the xz-plane; Y2-Y2 portion in FIG. 4A) defined by the axial direction (corresponding to the vertical direction z) along which the rotation center axis AX is aligned and the radial direction of the rotation center axis AX (corresponding to the first horizontal direction x) of the traveling device 500.

In the following, FIG. 4A and FIG. 4D will be used to describe each part of the repair mechanism 55.

### [C-4-1] Storage Part 551

In the repair mechanism 55, the storage part 551 is configured to store the repair material RM.

The storage part 551 is configured, for example, to supply the repair material RM to the nozzle 552 by supplying air from an external air pump P55. The storage part 551 includes, for example, a syringe part that stores the repair material RM inside and a plunger part that is housed inside the syringe part, and the plunger part moves inside the syringe part when air is supplied from the air pump P55. As a result, in the storage part 551, the repair material RM is discharged from a syringe discharge port provided in the syringe part.

The repair material RM is, for example, an ultraviolet-curable resin and is stored in a liquid state in the storage part 551. The storage part 551 is preferably removable from and attachable to the traveling device 500. The storage part 551 may be configured to supply the repair material RM to the nozzle 552 when a piston is pushed into the storage part 551 by an external force (such as a motor or solenoid).

### [C-4-2] Nozzle 552

In the repair mechanism 55, the nozzle 552 is configured to discharge the repair material RM from a nozzle discharge port S552 onto an application surface including the boundary portions BL1 and BL2 between the stator core 41 and the stator wedge 43 as the repair object parts.

In this embodiment, the nozzle 552 is supported by the skid 555. The nozzle 552 may be formed as an integral part of the skid 555.

### [C-4-3] Scraper 553

In the repair mechanism 55, the scraper 553 is provided to uniformize the thickness of the repair material RM discharged onto the application surface including the boundary portions BL1 and BL2.

In this embodiment, the scraper 553 is fixed inside the traveling device casing unit 501 so that a gap is interposed between a tip of the scraper 553 and the inner peripheral surface of the stator 23. The scraper 553 may have a structure using a spring and a skid, as in the case of the nozzle 552, to maintain a constant gap.

### [C-4-4] Solidification Device 554

In the repair mechanism 55, the solidification device 554 is provided to solidify the repair material RM that is discharged in the liquid state onto the application surface including the boundary portions BL1 and BL2.

In this embodiment, the solidification device 554 includes, for example, an ultraviolet irradiation lamp and ultraviolet light is irradiated from the ultraviolet irradiation lamp onto the repair material RM, which is the ultraviolet-curable resin. As a result, the repair material RM, which is the ultraviolet-curable resin, hardens and goes from the liquid state to a solid state.

### [C-4-5] Skid 555

In the repair mechanism 55, the skid 555 includes a first skid surface SK1 and a second skid surface SK2. In the skid 555, the first skid surface SK1 is a surface facing the application surface (inner peripheral surface of the stator 23) to which the repair material RM is applied in the gap AG. The second skid surface SK2 is a surface located on an opposite side of the first skid surface SK1 and faces an inner surface of the traveling device casing unit 501.

A biasing member 5551 is interposed between the second skid surface SK2 and the inner surface of the traveling device casing unit 501. The biasing member 5551 is, for example, a spring, which biases the skid 555 to press the first skid surface SK1 against the application surface to which the repair material RM is applied.

Furthermore, an operation fulcrum part AF is provided on the inner surface of the traveling device casing unit 501 facing the second skid surface SK2. The skid 555 is supported by the operation fulcrum part AF at a portion of the second skid surface SK2 located on the forward side TFw of the traveling direction TD during repair (on the left side of the second skid surface SK2 in FIG. 4D). In other words, the skid 555 can pivot with respect to the application surface to which the repair material RM is applied by the operation fulcrum part AF. This structure allows the distance between the tip of the nozzle 552 and the stator 23 to be kept constant. Even when the surface of the stator 23 is uneven, as in the case of paint or wedge joints, the tip of the nozzle 552 does not come into contact with the stator 23 and does not move far away from the stator 23, so the repair material RM can be applied at a stable thickness. The skid 555 may be configured to move in a vertical direction (in a direction of expansion and contraction of the biasing member 5551) using a guide (slider), for example, in addition to the pivot by the fulcrum AF.

A skid flow path FSK is formed in the skid 555. The skid flow path FSK is connected to a tube 556 at one end and to the nozzle 552 at the other end. The tube 556 is flexible and is provided to supply the repair material RM from the storage part 551 to the skid flow path FSK. Here, the tube 556 is connected to a side surface of the skid 555 that is located on the forward side TFw of the traveling direction TD during repair than the operation fulcrum part AF. This prevents that the pivot of the skid 555 is hindered by stiffness of the tube 556. When the skid 555 moves linearly, the tube 556 is attached at an appropriate position that does not interfere with the linear movement of the skid 555, taking into consideration a position of the guide, the structure, the stiffness of the tube 556, and the like.

### [D] Operation of Repair System 800

The operation of the repair system 800 (see FIG. 3) when performing repairs of the rotary electric machine 20 (see FIG. 1) is described.

As described above, this embodiment shows a case in which the repair is performed by applying the repair material RM to the boundary portions BL1 and BL2 between the stator core 41 and the stator wedge 43 due to a defect (loosening, or other defects) in the fixing state in which the stator wedge 43 is fixed to the stator slot KS of the stator core 41.

When performing the above repair of the rotary electric machine 20, the traveling device 500 is inserted into the gap AG interposed between the rotor 22 and stator 23, as illustrated in FIG. 4A to FIG. 4D. The traveling device 500 inserted into the gap AG travels in the vertical direction z with the crawlers 510 while being attracted to the stator 23 by the magnetic force of the permanent magnets 515. Here, the traveling device 500 travels while the permanent magnets 515 and the stator 23 are not in close contact and are separated, whereas the crawlers 510 and the stator 23 are in close contact.

When repairing the rotary electric machine 20, the moving operation of the traveling device 500 is controlled by the control device 600 (see FIG. 3). Here, the control device 600 controls the operation of the crawlers 510 that make up the moving mechanism 51 in the traveling device 500 based on repair object position information and traveling device position information. The repair object position information is information regarding the position of the repair object part in the rotary electric machine 20 and is information that is input to the control device 600 in advance. The traveling device position information is information regarding the position of the traveling device 500 in the rotary electric machine 20, for example, information about a moving distance of the traveling device 500 converted from the number of rotations of the crawler 510 when the traveling device 500 moves.

In this embodiment, the control device 600 performs “straight-ahead control” so that the traveling device 500 travels along the axial direction without meandering with respect to the axial direction when the traveling device 500 travels for “repair” in the gap AG between the rotor 22 and stator 23. The “straight-ahead control” is performed using the imaging data acquired by the imaging device 52 capturing the image.

In the following, concrete control contents for “straight-ahead control” and concrete control contents for “repair” will be described one after the other. [D-1] Straight-ahead Control

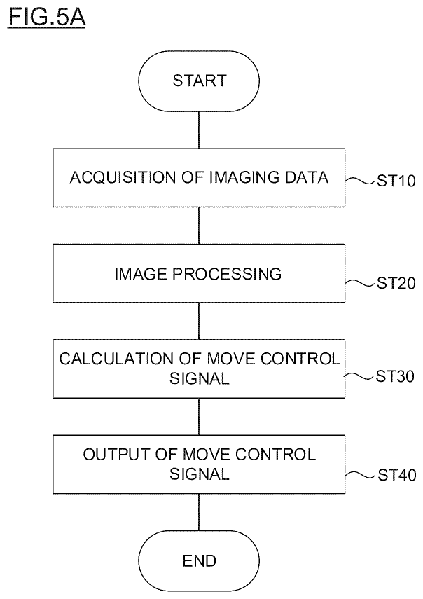

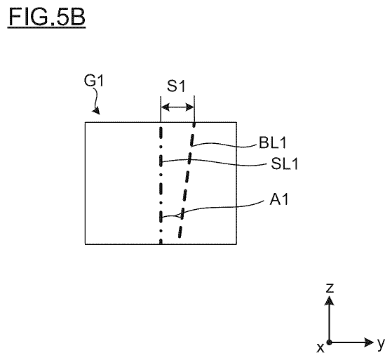

FIG. 5A is a flow diagram illustrating operations of the “straight-ahead control” in the repair system 800 of this embodiment. FIG. 5B is a diagram illustrating an example of imaging data used when the “straight-ahead control” is performed in the repair system 800 of this embodiment.

### [D-1-1] Acquisition of Imaging Data (ST10)

As illustrated in FIG. 5A, first, imaging data is acquired (ST10) to perform the “straight-ahead control”.

Here, when the traveling device 500 travels in the gap AG, the imaging device 52 acquires the imaging data by capturing images and outputs the imaging data to the control device 600. As described above, the imaging device 52 is controlled by the control device 600 to capture an image of the portion including the boundary portion BL1 between the stator core 41 and the stator wedge 43 on the inner peripheral surface of the stator 23 and to acquire the imaging data.

### [D-1-2] Image Processing (ST20)

Next, as illustrated in FIG. 5A, image processing is performed (ST20).

Here, the control device 600 performs the image processing on imaging data G1.

Concretely, as illustrated in FIG. 5B, a target position SL1 of the boundary portion BL1 is defined in the imaging data G1. The target position SL1 is set along a straight-ahead direction of the traveling device 500 in the imaging data G1.

As illustrated in FIG. 5B, feature points regarding the boundary portion BL1 are detected in the imaging data G1 by the image processing. The position of the boundary portion BL1 in the imaging data G1 is thereby determined.

Then, a state in which the boundary portion BL1 actually detected in the imaging data G1 is separated from the target position SL1 is grasped. Here, an angle A1 at which the linear boundary portion BL1 actually detected in the imaging data G1 is inclined with respect to the linear target position SL1 is determined. Also, a distance SI at which the linear boundary portion BL1 actually detected in the imaging data G1 is separated from the linear target position SL1 is determined.

### [D-1-3] Calculation of Move Control Signal (ST30)

Next, as illustrated in FIG. 5A, a move control signal is calculated (ST30).

Here, based on each result (angle A1, distance S1) determined by the above image processing, the control device 600 determines the move control signal to control the operation of the moving mechanism 51.

The control device 600 determines the move control signal to adjust the operations of the crawlers 510 making up the moving mechanism 51a and the crawlers 510 making up the moving mechanism 51b so that the angle A1 and distance S1 are each zero by the control. For example, the move control signal is determined using a look-up table or other tables that associates the results (angle A1 and distance S1) determined by the image processing with operation conditions of the crawlers 510 making up the moving mechanism 51a and the crawlers 510 making up the moving mechanism 51b.

The move control signal is determined so that the boundary portion BL1 detected in the imaging data G1 matches the target position SL1 after the crawlers 510 making up the moving mechanism 51a and the crawlers 510 making up the moving mechanism 51b are driven.

Concretely, the move control signal is determined under conditions of the number of rotations where the larger an absolute value of the angle A1 determined by the above image processing, the larger the difference between the number of rotations of the crawlers 510 that make up the moving mechanism 51a and that of the crawlers 510 that make up the moving mechanism 51b. Further, the move control signal is determined so that the larger an absolute value of the distance S1 determined by the above image processing, the longer the drive time to drive the crawlers 510 making up the moving mechanism 51a and the crawlers 510 making up the moving mechanism 51b under the above conditions of the number of rotations.

### [D-1-4] Output of Move Control Signal (ST40)

Next, as illustrated in FIG. 5A, the move control signal is output (ST40).

Here, the control device 600 outputs the move control signal to the traveling device 500. As a result, in the traveling device 500, the crawlers 510 making up the moving mechanism 51a and the crawlers 510 making up the moving mechanism 51b are driven based on the move control signal. As a result, the boundary portion BL1 detected in the imaging data G1 matches the target position SL1.

The “straight-ahead control” made up of each of the above steps is repeatedly performed when the traveling device 500 travels along the axial direction to perform the repair. After performing the repair of the stator wedge 43 installed in one stator slot KS, the traveling device 500 moves in the rotation direction R to perform the repair of the stator wedge 43 installed in the other stator slot KS, and the “straight-ahead control” is performed in the same manner as above.

### [D-2] Repair

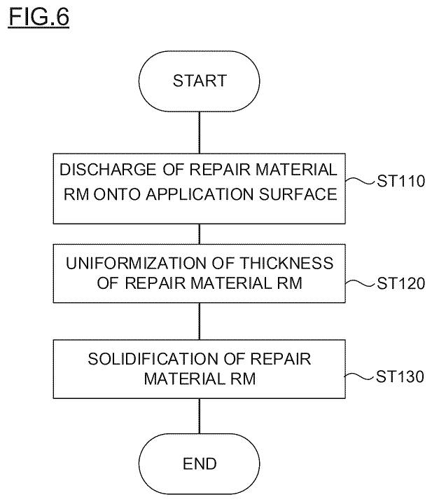

FIG. 6 is a flow diagram illustrating operations when performing the “repair” in the repair system 800 of this embodiment.

The operations when performing the “repair” are described using FIG. 6 along with FIG. 4A and FIG. 4D.

[D-2-1] Discharge of Repair Material RM onto Application Surface

When performing the “repair,” the repair material RM is first discharged onto the application surface (ST110), as illustrated in FIG. 6.

Here, as illustrated in FIG. 4A and FIG. 4D, the repair material RM stored in the storage part 551 is supplied to the skid flow path FSK of the skid 555 through the tube 556 by the control device 600 driving the air pump P55. The repair material RM supplied to the skid flow path FSK of the skid 555 is then discharged from the nozzle discharge port S552 of the nozzle 552 to the application surface.

In this embodiment, the repair material RM is, for example, the ultraviolet-curable resin, which is discharged from the nozzle discharge port S552 in the liquid state. The application surface includes the boundary portions BL1 and BL2 between the stator core 41 and the stator wedge 43 as the repair object parts.

When discharging the repair material RM onto the application surface, the traveling device 500 travels along the axial direction by the “straight-ahead control” as described above. Therefore, the boundary portions BL1 and BL2 extending in the axial direction are continuously covered in the axial direction by the repair material RM discharged from the nozzle discharge port S552.

The control device 600 preferably controls the operation of the air pump P55 so that the amount of the repair material RM discharged per unit time from the nozzle discharge port S552 of the nozzle 552 is adjusted (increased or decreased) according to the speed at which the traveling device 500 travels.

### [D-2-2] Uniformization of Thickness of Repair Material RM

Next, the thickness of the repair material RM is uniformized as illustrated in FIG. 6 (ST120).

Here, as illustrated in FIG. 4A and FIG. 4D, as the traveling device 500 travels, the repair material RM discharged onto the application surface passes through the gap between the scraper 553 and the application surface. As a result, a surface of the repair material RM discharged from the nozzle discharge port S552 onto the application surface is scraped by the scraper 553, resulting in a uniform thickness of the repair material RM.

### [D-2-3] Solidification of Repair Material RM

Next, the repair material RM is solidified as illustrated in FIG. 6 (ST130).

Here, as illustrated in FIG. 4A and FIG. 4D, the control device 600 drives the solidification device 554 to solidify the repair material RM discharged in the liquid state onto the application surface.

In this embodiment, the repair material RM is, for example, the ultraviolet-curable resin, and the solidification device 554 includes, for example, an ultraviolet irradiation lamp. In this case, the solidification of the repair material RM is performed by irradiating the repair material RM, which is the ultraviolet-curable resin, with the ultraviolet light from the ultraviolet irradiation lamp making up the solidification device 554.

Thus, the boundary portions BL1 and BL2 between the stator core 41 and the stator wedge 43 are covered by the solidified repair material RM, so that defects (looseness, or other defects) that occur in the fixing state where the stator wedge 43 is fixed to the stator slot KS of the stator core 41 are repaired.

### [E] Summary

As described above, the repair system 800 of this embodiment includes the traveling device 500 and the control device 600, and the traveling device 500 has the moving mechanism 51, the imaging device 52, and the repair mechanism 55. In the traveling device 500, the moving mechanism 51 is configured to move the traveling device 500 in the gap AG interposed between the rotor 22 and stator 23 in the rotary electric machine 20. The imaging device 52 is configured to acquire the imaging data by capturing the image of the boundary portion BL1 between the stator core 41 and the stator wedge 43 when the traveling device 500 travels in the gap AG. The repair mechanism 55 is configured to repair the boundary portions BL1 and BL2 between the stator core 41 and the stator wedge 43 in the gap AG.

In this embodiment, when repairing the boundary portions BL1 and BL2, the control device 600 controls the operation of the moving mechanism 51 so that the position of the boundary portion BL1 in the imaging data matches the target position SL1 defined for the boundary portion BL1 in the imaging data to travel the traveling device 500 along an extending direction of the boundary portions BL1 and BL2 (see FIG. 5B). The control device 600 controls the operation of the repair mechanism 55 to apply the repair material RM onto the boundary portions BL1 and BL2 by discharging the repair material RM from the nozzle discharge port S552 of the nozzle 552 while the traveling device 500 is traveled along the extending direction of the boundary portions BL1 and BL2 (see FIG. 4A, FIG. 4D).

Therefore, according to the repair system 800 of this embodiment, it is easy to achieve efficient repairs using the traveling device 500.

In this embodiment, the repair mechanism 55 has the scraper 553. Therefore, in this embodiment, the scraper 553 can be used to uniformize the thickness of the repair material RM discharged from the nozzle discharge port S552 of the nozzle 552 onto the boundary portions BL1 and BL2 (see FIG. 4D). In this embodiment, the repair mechanism 55 includes the solidification device 554. Therefore, in this embodiment, the repair material RM discharged in the liquid state from the nozzle discharge port S552 of the nozzle 552 onto the boundary portions BL1 and BL2 can be solidified using the solidification device 554 (see FIG. 4D). This makes it easy to achieve even more efficient repair in this embodiment.

In this embodiment, the repair mechanism 55 includes the skid 555 and the biasing member 5551, and the nozzle 552 is supported by the skid 555. The skid 555 has the first skid surface SK1 facing the application surface to which the repair material RM is applied and the second skid surface SK2 located on the opposite side of the first skid surface SK1 in the gap AG. The biasing member 5551 is provided on the second skid surface SK2 and biases the skid 555 to press the first skid surface SK1 against the application surface. The skid 555 is pivotally supported by the operation fulcrum part AF with respect to the application surface to which the repair material RM is applied. Therefore, in this embodiment, even if the application surface is not completely flat and uneven (such as “undulation”), the skid 555 pivots to follow the unevenness of the application surface using the operation fulcrum part AF as a fulcrum (see FIG. 4D) when the traveling device 500 travels. As a result, the repair material RM is discharged while the distance between the nozzle discharge port S552 of the nozzle 552 supported by the skid 555 and the application surface to which the repair material RM is applied is maintained constant. As a result, the repair material RM can be accurately discharged onto the boundary portions BL1 and BL2 of the application surface in this embodiment.

In this embodiment, the repair mechanism 55 includes the flexible tube 556 for supplying the repair material RM from the storage part 551 to the skid flow path FSK of the skid 555. The skid 555 is pivotally supported by the operation fulcrum part AF provided on the second skid surface SK2 side with respect to the application surface. The operation fulcrum part AF supports the skid 555 at a portion of the second skid surface SK2 that is located on the forward side TFw of the traveling direction TD during repair (left side of the second skid surface SK2 in FIG. 4D). The tube 556 is connected to the skid 555 so that it is located on the forward side TFw of the traveling direction TD during repair than the operation fulcrum part AF. When the skid 555 pivots around the operation fulcrum part AF by the traveling of the traveling device 500, displacement of the portion of the skid 555 that is located on the forward side TFw of the traveling direction TD during repair is smaller than the displacement of the portion of the skid 555 that is located on the backward side TBw of the traveling direction TD during repair. Therefore, in this embodiment, the tube 556 does not inhibit the pivot of the skid 555. In this embodiment, even when the skid 555 pivots around the operation fulcrum part AF, it is possible to prevent the tube 556 from falling out or being damaged because fluctuation of the tube 556 is small. When the tube 556 is flexible enough not to interfere with the pivot of the skid 555, this configuration is unnecessary. For example, when the skid 555 is a parallel movement type that moves in the vertical direction, this configuration is similarly unnecessary.

### [F] Modification Example

The above embodiment describes a case in which the traveling device 500 travels in the gap AG of the vertical-shaft type rotary electric machine 20 whose rotation center axis AX is along the vertical direction z. However, this embodiment is not limited to this case. The traveling device 500 may be traveled in the gap AG of the rotary electric machine 20 where the rotation center axis AX is along the horizontal direction x, for example, not along the vertical direction z.

The above embodiment describes a case in which the cable 700 is interposed between the traveling device 500 and the control device 600 and the two devices are configured to be communicable by wired communication, but is not limited to this case. The traveling device 500 and the control device 600 may be configured to be communicable by wireless communication. In the above embodiment, a case in which the control device 600 is installed outside the traveling device 500 is exemplified, but the control device 600 may be housed inside the traveling device 500.

In the traveling device 500 of the above embodiment, a case in which the moving mechanism 51 is configured to move the traveling device 500 using the crawlers 510 is described, but the embodiment is not limited to this case. The moving mechanism 51 may be configured to move the traveling device 500 without using the crawlers 510. For example, the moving mechanism 51 may be may be configured so that the wheels are in direct contact with the rotary electric machine 20 when traveling and the traveling direction of the traveling device 500 is changed using a steering mechanism to steer the wheels. Alternatively, the traveling device 500 may be suspended by a wire or the like, and the wire may be wound or unwound in the vertical direction to move the traveling device 500.

In the traveling device 500 of the above embodiment, a case in which the number of imaging devices 52 is singular is described, but the embodiment is not limited to this case. There can be a plurality of imaging devices 52, if necessary.

The traveling device 500 of the above embodiment may be equipped with equipment for inspection of the rotary electric machine 20. For example, a hammer and a microphone may be installed on the traveling device 500 to inspect the fixing state (looseness, or other states) of the stator wedge 43. In this case, the hammer strikes the stator wedge 43, the microphone detects the sound of the striking, and the acoustic data is analyzed to inspect the fixing state (looseness, or other states) of the stator wedge 43.

In the above embodiment, a case in which the storage part 551 of the repair mechanism 55 in the traveling device 500 is housed in the traveling device casing unit 501 is described, but the embodiment is not limited to this case. The storage part 551 may be provided outside of the traveling device casing unit 501.

In the traveling device 500 of the above embodiment, a case in which the repair mechanism 55 has the scraper 553 is described, but the embodiment is not limited to this case.

In the traveling device 500 of the above embodiment, a case in which the repair mechanism 55 has the solidification device 554 is described, but the embodiment is not limited to this case. When the repair material RM is a resin or the like that hardens naturally, the repair mechanism 55 does not need to have the solidification device 554. When the repair material RM is a thermosetting resin instead of the ultraviolet-curable resin, it is preferable to install a heater as the solidification device 554. Other drying devices including a fan or the like may be installed as the solidification device 554 to volatilize a solvent of the repair material RM.

In the traveling device 500 of the above embodiment, a case in which the skid 555 is pivotally supported by the operation fulcrum part AF in the repair mechanism 55 is described, but the embodiment is not limited to this case. Depending on the required repair quality, the repair mechanism 55 may not be provided with the skid 555.

### [F-1] Modification Example 1

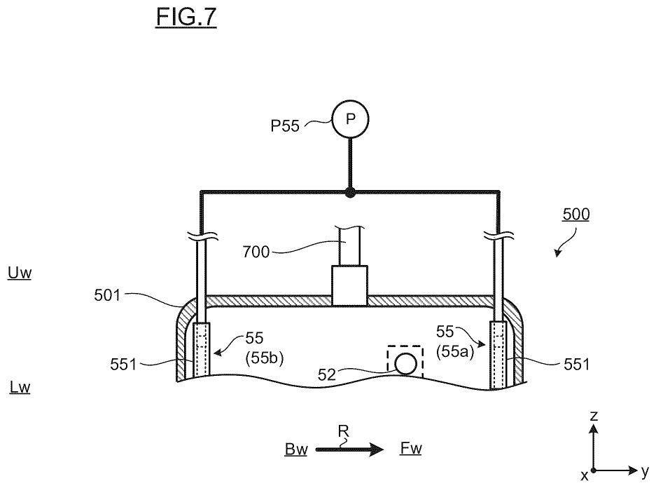

FIG. 7 is a diagram schematically illustrating a part of the traveling device 500 in Modification example 1.

As illustrated in FIG. 7, in this modification example, the air pump P55 may be configured to supply air to the storage part 551 (first storage part) of the repair mechanism 55a (first repair mechanism) as well as to supply air to the storage part 551 (second storage part) of the repair mechanism 55b (second repair mechanism), unlike in the above embodiment (see FIG. 4A).

### [F-2] Modification Example 2

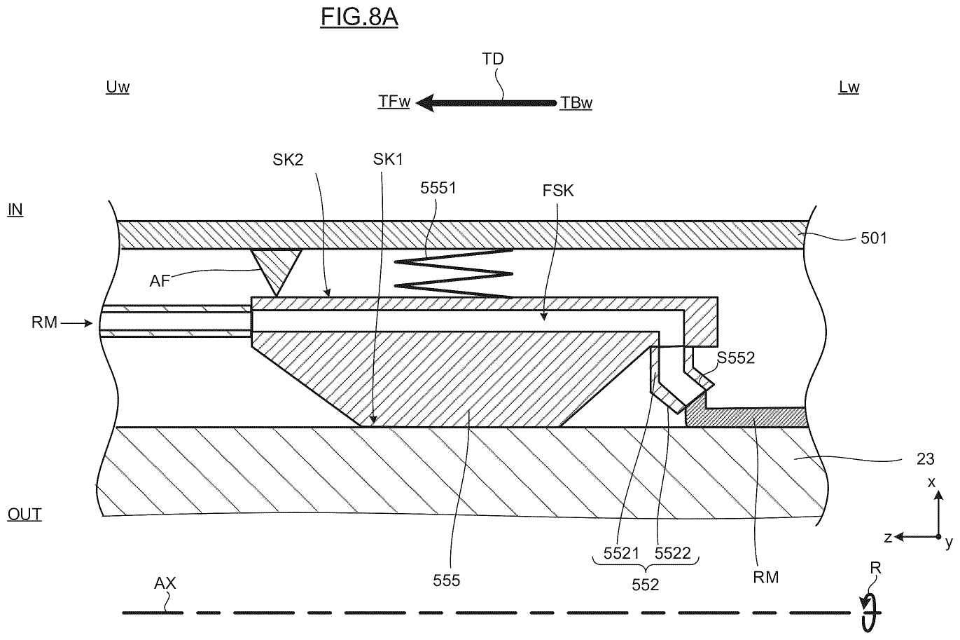

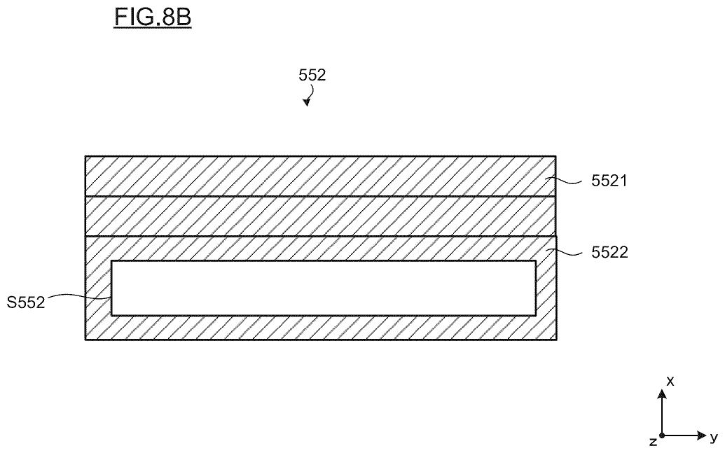

FIG. 8A is a diagram schematically illustrating an enlarged part where the repair mechanism 55 is provided in Modification example 2. FIG. 8B is a diagram schematically illustrating the nozzle 552 in Modification example 2.

In FIG. 8A, the same area as in FIG. 4D is illustrated. In FIG. 8B, the nozzle 552 is illustrated when the traveling direction TD during repair is a sight line.

As illustrated in FIG. 8A and FIG. 8B, in this modification example, the mode of the nozzle 552 differs from that of the above embodiment. The nozzle 552 in this modification example includes a first nozzle part 5521 and a second nozzle part 5522.

In the nozzle 552, the first nozzle part 5521 has an internal flow path along the radial direction of the rotation center axis AX. The first nozzle part 5521 is connected to the skid 555 at one end located on the inner peripheral side IN in the radial direction and is connected to the second nozzle part 5522 at the other end located on the outer peripheral side OUT in the radial direction (see FIG. 8A).

In the nozzle 552, the second nozzle part 5522 has an internal flow path that is not parallel to the radial direction of the rotation center axis AX. The internal flow path of the second nozzle part 5522 is inclined with respect to the radial direction so that the other end, which is located on the outer peripheral side OUT in the radial direction, is located on the backward side TBw of the traveling direction TD during repair than one end, which is located on the inner peripheral side IN in the radial direction (see FIG. 8A).

As illustrated in FIG. 8B, in this modification example, the nozzle discharge port S552 of the nozzle 552 is rectangular in shape with a circumferential direction (y-direction in FIG. 8B) being a major axis.

In this modification example, the thickness of the repair material RM discharged from the nozzle discharge port S552 becomes uniform. Therefore, in this modification example, the scraper 553 can be omitted, and thus simplification of the device can be achieved.

### Other Embodiments

While certain embodiments of the present invention have been described herein, these embodiments have been presented by way of example only, and are not intended to limit the scope of the inventions. The embodiments described herein may be embodied in a variety of other forms; furthermore, various omissions, substitutions, and changes may be made without departing from the spirit of the inventions. The embodiments and modifications fall within the scope and spirit of the inventions and fall within the scope of the inventions as set forth in claims and their equivalents.

### REFERENCE SIGNS LIST

1 . . . hydraulic turbine floor foundation,

1b . . . discharge pipe,

2 . . . rotary electric machine floor foundation,

10 . . . hydraulic turbine,

11 . . . hydraulic turbine rotor shaft,

12 . . . runner,

13 . . . upper cover,

14 . . . lower cover,

15 . . . guide vane,

16 . . . casing,

19 . . . hydraulic turbine bearing,

20 . . . rotary electric machine,

21 . . . rotary electric machine rotor shaft,

21a . . . rotary electric machine bearing,

21b . . . rotary electric machine bearing,

22 . . . rotor,

23 . . . stator,

24 . . . frame,

41 . . . stator core,

42 . . . stator coil,

43 . . . stator wedge,

51 . . . moving mechanism,

51a . . . moving mechanism,

51b . . . moving mechanism,

52 . . . imaging device,

55 . . . repair mechanism,

55a . . . repair mechanism,

55b . . . repair mechanism,

161 . . . speed ring,

201 . . . rotary shaft,

500 . . . traveling device,

501 . . . traveling device casing unit,

510 . . . crawler,

511 . . . sprocket wheel,

512 . . . roller wheel,

513 . . . idler wheel,

515 . . . permanent magnet,

551 . . . storage part,

552 . . . nozzle,

553 . . . scraper,

554 . . . solidification device,

555 . . . skid,

556 . . . tube,

600 . . . control device,

700 . . . cable,

800 . . . repair system,

5221 . . . objective lens,

5222 . . . imaging element,

5521 . . . first nozzle part,

5522 . . . second nozzle part,

5551 . . . biasing member,

FSK . . . skid flow path,

AG . . . gap,

P55 . . . air pump,

RM . . . repair material,

S552 . . . nozzle discharge port,

SK1 . . . first skid surface,

SK2 . . . second skid surface

What is claimed is:

1. A repair system, comprising:
a traveling device configured to travel while being inserted into a gap interposed between a rotor and stator in a rotary electric machine; and
a control device configured to control operation of the traveling device, wherein
the traveling device includes:
a moving mechanism configured to move the traveling device in the gap; and
a repair mechanism configured to repair a repair object part of the rotary electric machine in the gap, and
the repair mechanism includes:
a nozzle that discharges repair material for repairing the repair object part from a nozzle discharge port, wherein
the control device controls operation of the moving mechanism and operation of the repair mechanism so that the repair material is applied to the repair object part by discharging the repair material from the nozzle discharge port of the nozzle while the traveling device is moved when repairing the repair object part.

2. The repair system according to claim 1, wherein
the repair mechanism includes:
a scraper for uniformizing thickness of the repair material discharged from the nozzle discharge port of the nozzle to the repair object part.

3. The repair system according to claim 1, wherein
the repair mechanism includes:
a solidification device for solidifying the repair material discharged in a liquid state from the nozzle to the repair object part.

4. The repair system according to claim 1, wherein
the repair mechanism includes:
a storage part configured to store the repair material;
a skid that has a first skid surface facing an application surface to which the repair material is applied and a second skid surface located on an opposite side of the first skid surface in the gap; and
a biasing member provided on the second skid surface and biases the skid to press the first skid surface to the application surface, wherein
the nozzle is supported by the skid, and
the skid is provided with a skid flow path where the repair material flows from the storage part to the nozzle.

5. The repair system according to claim 4, wherein
the repair mechanism includes:
a flexible tube for supplying the repair material from the storage part to the skid flow path, wherein
the skid is pivotally supported by an operation fulcrum part provided on the second skid surface side with respect to the application surface,
the operation fulcrum part supports the skid at a portion that is located on a forward side of a traveling direction during repair where the traveling device moves when performing repair, and
the tube is connected to the skid so that the tube is located on the forward side of the traveling direction during repair than the operation fulcrum part.

6. The repair system according to claim 4, wherein
the storage part is configured to supply the repair material to the nozzle when air is supplied from an air pump,
at least a first repair mechanism and a second repair mechanism are included as the repair mechanism, and
the air pump is configured to supply air to a first storage part provided as the storage part in the first repair mechanism and to supply air to a second storage part provided as the storage part in the second repair mechanism.

7. The repair system according to claim 4, wherein
the storage part is configured to supply the repair material to the nozzle when air is supplied from an air pump, and
the control device controls operation of the air pump so that an amount of the repair material discharged per unit time from the nozzle discharge port of the nozzle is increased according to speed at which the traveling device travels.
